(19) United States
(12) Patent Application Publication
(10) Pub. No.: US 2023/0026810 A1
(43) Pub. Date: Jan. 26, 2023

(54) HIGH-FREQUENCY TRANSMISSION LCP FILM AND PREPARATION METHOD THEREOF

(71) Applicant: NINGXIA QINGYAN POLYMER MATERIALS CO.,LTD., Ningxia Hui Autonomous Region (CN)

(72) Inventors: Dongbao ZHANG, Ningxia Hui Autonomous Region (CN); Ran YU, Ningxia Hui Autonomous Region (CN); Liang XU, Ningxia Hui Autonomous Region (CN)

(21) Appl. No.: 17/467,422

(22) Filed: Sep. 6, 2021

(30) Foreign Application Priority Data
Jul. 23, 2021 (CN) 202110838652.2

(51) Int. Cl. C09K 19/38; C08G 63/83; C08J 3/12; C08J 5/18

(52) U.S. Cl. CPC C09K 19/3809; C08G 63/83; C08J 3/12; C08J 5/18; C08J 2367/04

(57) ABSTRACT

The disclosure discloses a high-frequency transmission LCP film and preparation method thereof. The preparation method comprises the following steps: (1) separately performing acetylation on monomers to obtain acetylated monomers; (2) performing high-temperature polymerization on the acetylated monomers, phenolic resin, acetic anhydride and zinc acetate, and performing pulverization to obtain liquid crystal copolyester; (3) ball milling the liquid crystal copolyester, an inorganic filler, a silane coupling agent and a glass fiber and mixing to obtain a mixture; and melt-plasticizing the mixture to form a film after cooling, performing longitudinal and transverse synchronous stretching, then winding and slitting the film to obtain a high-frequency transmission LCP film. In the disclosure, by adjusting the type and ratio of acetylated monomers and adding phenolic resin, a regular fibrous structure is obtained; and by adding an inorganic filler, a silane coupling agent and glass fibers, its mechanical properties are enhanced and dielectric loss is reduced, thereby obtaining an LCP film with low dielectric constant and low dielectric loss factor which can be applied to the fields of electronics, electricity, optical fiber, 5G communication and the like.

### TECHNICAL FIELD

The disclosure relates to a technical field of liquid crystal polymer, in particular to a high-frequency transmission LCP film and preparation method thereof.

### BACKGROUND OF THE INVENTION

Liquid crystal polymer (LCP) is a kind of polymer material which, after being melted by heat or dissolved by a solvent, loses its fluidity, but still maintains a partial orderly arrangement, thereby forms a polymer material having partial properties of both crystal and liquid. According to the application, LCP can be divided into a film grade, an injection molding grade and a fiber grade. wherein the LCP film can be used as an excellent carrier for high-frequency signal transmission and has characteristics of low hygroscopicity, high chemical resistance, and high gas barrier properties.

Meanwhile, LCP film belongs to a dielectric material with low dielectric constant and low dielectric loss factor, and can be widely used in 5G communications, mobile phone antennas, camera soft boards, laptop high-speed transmission wires, and smart watch antennas.

The development and application of LCP films are limited due to bottleneck problems, such as difficult control in the molding machining process and high requirements on material mechanical properties.

### SUMMARY OF THE INVENTION

In view of the above-mentioned shortcomings of the existing technologies, the object of the disclosure is to provide a high-frequency transmission LCP film and preparation method thereof, aiming to obtain an LCP film with low dielectric constant and low dielectric loss factor.

In one aspect of the disclosure, a method is provided for preparing high-frequency transmission LCP film, comprising the following steps:

(1) separately performing acetylation on monomers to obtain acetylated monomers;

(2) performing high-temperature polymerization on the acetylated monomers, phenolic resin, acetic anhydride and zinc acetate, and performing pulverization to obtain liquid crystal copolyester; and

(3) ball milling the liquid crystal copolyester, an inorganic filler, a silane coupling agent and a glass fiber, and mixing to obtain a mixture; and melt-plasticizing the mixture to form a film after cooling, performing longitudinal and transverse synchronous stretching, then winding and slitting to obtain a high-frequency transmission LCP film;

where the monomers are at least one of p-hydroxybenzoic acid, acetylated 2-hydroxy-6-naphthoic acid, acetylated 4-hydroxy-3-methoxybenzoic acid and acetylated 4-hydroxyphenylpyruvic acid.

According to some embodiments of the disclosure of the disclosure, the acetylation reaction includes: mixing monomers, acetic anhydride and a catalyst, and performing an acetylation reaction to obtain acetylated monomers.

According to some embodiments of the disclosure, the acetylation reaction includes: mixing monomers, acetic anhydride and a catalyst, and performing an acetylation reaction to obtain acetylated monomers;

where the catalyst is concentrated sulfuric acid; and

a mole ratio of the monomers and acetic anhydride is 1:1-3.

The method for preparing high-frequency transmission LCP film, wherein a condition of the acetylation reaction is: stirring for 1-3 h at 150-200° C., followed by stirring for 0.5-2 h in an ice-water bath.

According to some embodiments of the disclosure, a condition of the high-temperature polymerization is: reacting at 150-190° C. for 1-3 h, heating up to 200-240° C. for reaction for 1-4 h, then heating up to 250-290° C. for heat preservation for 2-5 h, and finally heating up to 300-330° C. for reaction for 1-3 h.

According to some embodiments of the disclosure, a mole ratio of the acetylated monomers, the phenolic resin, the acetic anhydride and the zinc acetate is 1:0.1-1:0.5-1:0.001-0.005.

The method for preparing high-frequency transmission LCP film, wherein the mixture includes components in parts by weight:

30-70 parts of liquid crystal copolyester;

10-30 parts of inorganic filler;

5-10 parts of silane coupling agent; and

10-40 parts of glass fiber.

According to some embodiments of the disclosure, the inorganic filler is at least one of silicon dioxide, graphene and carbon nanotubes;

the silane coupling agent is at least one of γ-aminopropyltriethoxysilane, γ-glycidoxypropyltrimethoxysilane and hexadecyltrimethoxysilane; and

a length of the glass fiber is 30-60 mm and a fiber diameter is 20-30 μm.

According to some embodiments of the disclosure, a duration of the ball milling is 8-12 h and a temperature of the melt-plasticizing is 280-350° C.

In another aspect of the disclosure, a high-frequency transmission LCP film is further provided, which is prepared by the method mentioned above, the high-frequency transmission LCP film has a thickness of 50-70 m; and a relative dielectric constant of 10 GHz is lower than 2.6 and a dielectric loss factor is lower than 0.01.

The disclosure discloses a high-frequency transmission LCP film and preparation method thereof. Firstly, by monomer acetylation, the reactivity of the monomers can be improved and the self-polymerization of the monomers and the oxidization of the hydroxyl group in the monomers can be prevented. Secondly, by adjusting the type and ratio of acetylated monomers and adding phenolic resin, the tight packing degree of molecular chains of regular polymer is reduced, thereby forming a regular fibrous structure. Finally, by adding an inorganic filler, a silane coupling agent and glass fibers, its mechanical properties are enhanced and dielectric loss is reduced, thereby obtaining an LCP film with low dielectric constant and low dielectric loss factor which can be applied to the fields of electronics, electricity, optical fiber, 5G communication and the like.

### DETAILED DESCRIPTION OF THE INVENTION

The disclosure provides a high-frequency transmission LCP film and preparation method thereof. In order to make the object, technical solutions, and effects of the disclosure clearer and definitive, the disclosure will be further described below in detail. It should be understood that the specific embodiments described herein are only intended to illustrate the disclosure, but not to limit the disclosure.

Particularly, a method for preparing high-frequency transmission LCP film according to some embodiments of the disclosure may comprise the following steps (1), (2) and (3).

At step (1), adding monomers and acetic anhydride into a three-necked flask, adding concentrated sulfuric acid as a catalyst, stirring for 1-3 h at 150-200° C. and then stirring for 0.5-2 h in an ice-water bath, followed by filtering, washing and drying to obtain acetylated monomers;

the monomer is p-hydroxybenzoic acid, 4-hydroxybenzoic acid, 2-hydroxy-6-naphthoic acid, 4-hydroxy-3-methoxybenzoic acid or 4-hydroxyphenylpyruvic acid; and a mole ratio of the monomers and acetic anhydride is 1:1-3.

At sept (2), adding the acetylated monomers, phenolic resin, acetic anhydride and zinc acetate into a three-necked flask with nitrogen under a stirring condition, reacting at 150-190° C. for 1-3 h, and heating up to 200-240° C. for reaction for 1-4 h, then heating up to 250-290° C. for heat preservation for 2-5 h, and finally heating up to 300-330° C. for reaction for 1-3 h, followed by pulverizing with a pulverizer, washing with ethanol, and drying to obtain a liquid crystal copolyester;

wherein a mass ratio of the acetylated monomers, phenolic resin, acetic anhydride and zinc acetate is 1:0.1-1:0.5-1:0.001-0.005.

At step (3), ball milling the liquid crystal copolyester, an inorganic filler, a silane coupling agent and a glass fiber for 8-12 h and mixing them to obtain a mixture; and melt-plasticizing the mixture at 280-350° C., cooling it to form a film, performing longitudinal and transverse synchronous stretching to the film, then winding and slitting the film to obtain a high-frequency transmission LCP film;

wherein the mixture includes components in parts by weight:

30-70 parts of liquid crystal copolyester;

10-30 parts of inorganic filler;

5-10 parts of silane coupling agent; and

10-40 parts of glass fiber.

The inorganic filler is at least one of silicon dioxide, graphene and carbon nanotubes;

the silane coupling agent is at least one of γ-aminopropyltriethoxysilane, γ-glycidoxypropyltrimethoxysilane and hexadecyltrimethoxysilane; and

the glass fiber has a length of 30-60 mm and a fiber diameter of 20-30 m.

Meanwhile, the disclosure further provides high-frequency transmission LCP film prepared by the method mentioned above, wherein the high-frequency transmission LCP film has a thickness of 50-70 μm; and a relative dielectric constant of 10 GHz is lower than 2.6 and a dielectric loss factor is lower than 0.01.

The high-frequency transmission LCP film and preparation method thereof will be further illustrated through specific embodiments of the disclosure.

### Embodiment 1

An embodiment of the disclosure provides a method for preparing high-frequency transmission LCP film, including the following steps:

(1) adding 0.1 mol of p-hydroxybenzoic acid, 0.15 mol of acetic anhydride and 0.2 g of concentrated sulfuric acid into a three-necked flask under a stirring condition, stirring them for 3 h at 160° C. and then stirring for 0.5 h in an ice-water bath, followed by filtering, washing and drying to obtain a acetylated p-hydroxybenzoic acid.

Adding 0.1 mol of 2-hydroxy-6-naphthoic acid, 0.15 mol of acetic anhydride and 0.2 g of concentrated sulfuric acid into a three-necked flask under a stirring condition, stirring them for 3 h at 160° C. and then stirring for 0.5 h in an ice-water bath, followed by filtering, washing and drying to obtain acetylated 2-hydroxy-6-naphthoic acid.

(2) adding 0.09 mol of acetylated p-hydroxybenzoic acid, 0.01 mol of acetylated 2-hydroxy-6-naphthoic acid, 0.1 g of phenolic resin, 10 ml of acetic anhydride and 0.05 g of zinc acetate into a three-necked flask with nitrogen under a stirring condition, reacting at 170° C. for 1 h, heating up to 220° C. for reaction for 2 h, then heating up to 260° C. for heat preservation for 4 h, and finally heating up to 300° C. for reaction for h, followed by pulverizing with a pulverizer, washing with ethanol, and drying to obtain a liquid crystal copolyester.

(3) ball milling 30 parts of the liquid crystal copolyester, 30 parts of graphene, 10 parts of γ-aminopropyltriethoxysilane and 30 parts of glass fiber for 8 h and mixing them to obtain a mixture; and melt-plasticizing the mixture at 280° C., cooling it to form a film, performing longitudinal and transverse synchronous stretching, then winding and slitting the film to obtain a high-frequency transmission LCP film.

The glass fiber has a length of 60 mm and a fiber diameter of 30 m.

An embodiment of the disclosure provides a high-frequency transmission LCP film prepared by the method of embodiment 1. The high-frequency transmission LCP film of embodiment 1 has a thickness of 63 m; and a relative dielectric constant of the high-frequency transmission LCP film at an electromagnetic wave frequency of 10 GHz is 2.38 and a dielectric loss factor is 0.0046.

### Embodiment 2

An embodiment of the disclosure provides a method for preparing high-frequency transmission LCP film, including the following steps:

(1) adding 0.1 mol of p-hydroxybenzoic acid, 0.15 mol of acetic anhydride and 0.2 g of concentrated sulfuric acid into a three-necked flask under a stirring condition, stirring for 3 h at 160° C. and then stirring for 0.5 h in an ice-water bath, followed by filtering, washing and drying to obtain acetylated p-hydroxybenzoic acid.

Adding 0.1 mol of 4-hydroxy-3-methoxybenzoic acid, 0.15 mol of acetic anhydride and 0.2 g of concentrated sulfuric acid into a three-necked flask under a stirring condition, stirring for 3 h at 160° C. and then stirring for 0.5 h in an ice-water bath, followed by filtering, washing and drying to obtain acetylated 4-hydroxy-3-methoxybenzoic acid.

(2) adding 0.07 mol of acetylated p-hydroxybenzoic acid, 0.03 mol of acetylated 4-hydroxy-3-methoxybenzoic acid, 0.2 g of phenolic resin, 10 ml of acetic anhydride and 0.05 g of zinc acetate into a three-necked flask with nitrogen under a stirring condition, reacting at 190° C. for 1 h, heating up to 240° C. for reaction for 1 h, then heating up to 290° C. for heat preservation for 2 h, and finally heating up to 330° C. for reaction for 3 h, followed by pulverizing with a pulverizer, washing with ethanol, and drying to obtain a liquid crystal copolyester.

(3) ball milling 70 parts of the liquid crystal copolyester, 10 parts of carbon nanotubes, 10 parts of γ-glycidoxypropyltrimethoxysilane and 10 parts of glass fiber for 12 h and mixing them to obtain a mixture; and melt-plasticizing the mixture at 350° C., cooling it to form a film, performing longitudinal and transverse synchronous stretching, then winding and slitting the film to obtain a high-frequency transmission LCP film.

The glass fiber has a length of 30 mm and a fiber diameter of 20 μm.

An embodiment of the disclosure provides high-frequency transmission LCP film prepared by the method of embodiment 2. The high-frequency transmission LCP film of embodiment 2 has a thickness of 51 μm; and a relative dielectric constant of 10 GHz is 2.52 and a dielectric loss factor is 0.0042.

### Embodiment 3

An embodiment of the disclosure provides a method for preparing high-frequency transmission LCP film, including the following steps:

(1) adding 0.1 mol of p-hydroxybenzoic acid, 0.3 mol of acetic anhydride and 0.2 g of concentrated sulfuric acid into a three-necked flask under a stirring condition, stirring for 1 h at 300° C. and then stirring for 0.5 h in an ice-water bath, followed by filtering, washing and drying to obtain acetylated p-hydroxybenzoic acid.

adding 0.1 mol of 4-hydroxyphenylpyruvic acid, 0.3 mol of acetic anhydride and 0.2 g of concentrated sulfuric acid into a three-necked flask under a stirring condition, stirring for 1 h at 300° C. and then stirring for 0.5 h in an ice-water bath, followed by filtering, washing and drying to obtain acetylated 4-hydroxyphenylpyruvic acid.

(2) adding 0.01 mol of acetylated p-hydroxybenzoic acid, 0.09 mol of acetylated 4-hydroxyphenylpyruvic acid, 0.1 g of phenolic resin, 10 ml of acetic anhydride and 0.05 g of zinc acetate into a three-necked flask with nitrogen under a stirring condition, reacting at 150° C. for 3 h, heating up to 200° C. for reaction for 4 h, then heating up to 250° C. for heat preservation for 5 h, and finally heating up to 300° C. for reaction for 1 h, followed by pulverizing with a pulverizer, washing with ethanol and drying to obtain a liquid crystal copolyester.

(3) ball milling 55 parts of the liquid crystal copolyester, 30 parts of silicon dioxide, 5 parts of hexadecyltrimethoxysilane and 10 parts of glass fiber for 10 h and mixing them to obtain a mixture; and melt-plasticizing the mixture at 350° C., cooling it to form a film, performing longitudinal and transverse synchronous stretching, then winding and slitting the film to obtain a high-frequency transmission LCP film.

The glass fiber has a length of 50 mm and a fiber diameter of 25 m.

An embodiment of the disclosure provides high-frequency transmission LCP film prepared by the method of embodiment 3. The high-frequency transmission LCP film of embodiment 3 has a thickness of 62 m; and a relative dielectric constant of 10 GHz is 2.36, and a dielectric loss factor is 0.0072.

### Embodiment 4

An embodiment of the disclosure provides a method for preparing high-frequency transmission LCP film, including the following steps:

(1) adding 0.1 mol of p-hydroxybenzoic acid, 0.15 mol of acetic anhydride and 0.2 g of concentrated sulfuric acid into a three-necked flask under a stirring condition, stirring for 3 h at 160° C. and then stirring for 0.5 h in an ice-water bath, followed by filtering, washing and drying to obtain acetylated p-hydroxybenzoic acid.

adding 0.1 mol of 2-hydroxy-6-naphthoic acid, 0.15 mol of acetic anhydride and 0.2 g of concentrated sulfuric acid into a three-necked flask under a stirring condition, stirring for 3 h at 160° C. and then stirring for 0.5 h in an ice-water bath, followed by filtering, washing and drying to obtain acetylated 2-hydroxy-6-naphthoic acid.

(2) adding 0.05 mol of acetylated p-hydroxybenzoic acid, 0.05 mol of acetylated 2-hydroxy-6-naphthoic acid, 10 ml of acetic anhydride, 0.15 g of phenolic resin and 0.05 g of zinc acetate into a three-necked flask with nitrogen under a stirring condition, reacting at 170° C. for 1 h, heating up to 220° C. for reaction for 2 h, then heating up to 260° C. for heat preservation for 4 h, and finally heating up to 300° C. for reaction for 1 h, followed by pulverizing with a pulverizer, washing with ethanol and drying to obtain a liquid crystal copolyester.

(3) ball milling 40 parts of the liquid crystal copolyester, 10 parts of graphene, 10 parts of hexadecyltrimethoxysilane and 40 parts of glass fiber for 10 h and mixing them to obtain a mixture; and melt-plasticizing the mixture at 300° C., cooling it to form a film, performing longitudinal and transverse synchronous stretching, then winding and slitting the film to obtain a high-frequency transmission LCP film.

The glass fiber has a length of 40 mm and a fiber diameter of 30 m.

An embodiment of the disclosure provides a high-frequency transmission LCP film prepared by the method of embodiment 4. The high-frequency transmission LCP film of embodiment 4 has a thickness of 69 m; and a relative dielectric constant of 10 GHz is 2.29 and a dielectric loss factor is 0.0081.

It should be understood that the application of the disclosure is not limited to the above-mentioned embodiments. For those of ordinary skill in the art, improvements or changes can be made based on the above-mentioned description, and all these improvements and changes should fall within the protection scope of the appended claims of the disclosure.

1. A method for preparing high-frequency transmission LCP film, comprising the following steps:
(1) separately performing acetylation on monomers to obtain acetylated monomers;
(2) performing high-temperature polymerization on the acetylated monomers, phenolic resin, acetic anhydride and zinc acetate, and performing pulverization to obtain liquid crystal copolyester; and
(3) ball milling the liquid crystal copolyester, an inorganic filler, a silane coupling agent and a glass fiber and mixing to obtain a mixture; and melt-plasticizing the mixture to form a film after cooling, performing longitudinal and transverse synchronous stretching, then winding and slitting the film to obtain a high-frequency transmission LCP film;
where the monomers are at least one of p-hydroxybenzoic acid, acetylated 2-hydroxy-6-naphthoic acid, acetylated 4-hydroxy-3-methoxybenzoic acid and acetylated 4-hydroxyphenylpyruvic acid.

2. The method for preparing high-frequency transmission LCP film as claimed in claim 1, wherein the acetylation reaction includes: mixing monomers, acetic anhydride and a catalyst, and performing an acetylation reaction to obtain acetylated monomers.

3. The method for preparing high-frequency transmission LCP film as claimed in claim 2, wherein the acetylation reaction includes: mixing monomers, acetic anhydride and a catalyst, and performing an acetylation reaction to obtain acetylated monomers;
where the catalyst is concentrated sulfuric acid; and
a mole ratio of the monomers and acetic anhydride is 1:1-3.

4. The method for preparing high-frequency transmission LCP film as claimed in claim 2, wherein a condition of the acetylation reaction is: stirring for 1-3 h at 150-200° C., followed by stirring for 0.5-2 h in an ice-water bath.

5. The method for preparing high-frequency transmission LCP film as claimed in claim 1, wherein a condition of the high-temperature polymerization is: reacting at 150-190° C. for 1-3 h, heating up to 200-240° C. for reaction for 1-4 h, then heating up to 250-290° C. for heat preservation for 2-5 h, and finally heating up to 300-330° C. for reaction for 1-3 h.

6. The method for preparing high-frequency transmission LCP film as claimed in claim 1, wherein a mole ratio of the acetylated monomers, the phenolic resin, the acetic anhydride and the zinc acetate is 1:0.1-1:0.5-1:0.001-0.005.

7. The method for preparing high-frequency transmission LCP film as claimed in claim 1, wherein the mixture includes components in parts by weight:
30-70 parts of liquid crystal copolyester;
10-30 parts of inorganic filler;
5-10 parts of silane coupling agent; and
10-40 parts of glass fiber.

8. The method for preparing high-frequency transmission LCP film as claimed in claim 1, wherein the inorganic filler is at least one of silicon dioxide, graphene and carbon nanotubes;
the silane coupling agent is at least one of γ-aminopropyltriethoxysilane, γ-glycidoxypropyltrimethoxysilane and hexadecyltrimethoxysilane; and
the glass fiber has a length of 30-60 mm and a fiber diameter of 20-30 m.

9. The method for preparing high-frequency transmission LCP film as claimed in claim 1, wherein a duration of the ball milling is 8-12 h and a temperature of the melt-plasticizing is 280-350° C.

10. A high-frequency transmission LCP film, wherein being prepared by the method as claimed in claim 1, the high-frequency transmission LCP film has a thickness of 50-70 m; and a relative dielectric constant of the high-frequency transmission LCP film at an electromagnetic wave frequency of 10 GHz is lower than 2.6 and a dielectric loss factor is lower than 0.01.

11. A high-frequency transmission LCP film as claimed in claim 10, wherein the acetylation reaction includes: mixing monomers, acetic anhydride and a catalyst, and performing an acetylation reaction to obtain acetylated monomers.

12. A high-frequency transmission LCP film as claimed in claim 11, wherein the acetylation reaction includes: mixing monomers, acetic anhydride and a catalyst, and performing an acetylation reaction to obtain acetylated monomers;
where the catalyst is concentrated sulfuric acid; and
a mole ratio of the monomers and acetic anhydride is 1:1-3.

13. A high-frequency transmission LCP film as claimed in claim 11, wherein a condition of the acetylation reaction is: stirring for 1-3 h at 150-200° C., followed by stirring for 0.5-2 h in an ice-water bath.

14. A high-frequency transmission LCP film as claimed in claim 10, wherein a condition of the high-temperature polymerization is: reacting at 150-190° C. for 1-3 h, heating up to 200-240° C. for reaction for 1-4 h, then heating up to 250-290° C. for heat preservation for 2-5 h, and finally heating up to 300-330° C. for reaction for 1-3 h.

15. A high-frequency transmission LCP film as claimed in claim 10, wherein a mole ratio of the acetylated monomers, the phenolic resin, the acetic anhydride and the zinc acetate is 1:0.1-1:0.5-1:0.001-0.005.

16. A high-frequency transmission LCP film as claimed in claim 10, wherein the mixture includes components in parts by weight:
30-70 parts of liquid crystal copolyester;
10-30 parts of inorganic filler;
5-10 parts of silane coupling agent; and
10-40 parts of glass fiber.

17. A high-frequency transmission LCP film as claimed in claim 10, wherein the inorganic filler is at least one of silicon dioxide, graphene and carbon nanotubes;
the silane coupling agent is at least one of γ-aminopropyltriethoxysilane, γ-glycidoxypropyltrimethoxysilane and hexadecyltrimethoxysilane; and
the glass fiber has a length of 30-60 mm and a fiber diameter of 20-30 m.

18. A high-frequency transmission LCP film as claimed in claim 10, wherein a duration of the ball milling is 8-12 h and a temperature of the melt-plasticizing is 280-350° C.
